(19) United States
(12) Patent Application Publication
(10) Pub. No.: US 2024/0422084 A1
(43) Pub. Date: Dec. 19, 2024

(54) System and Method for AI-Assisted Network Audits

(71) Applicant: Aviz Networks, Inc., San Jose, CA (US)

(72) Inventors: Chidambaram Bhagavathiperumal, Livermore, CA (US); Vishal Shukla, San Jose, CA (US); Madhu Paluru, Fremont, CA (US)

(73) Assignee: Aviz Networks, Inc., San Jose, CA (US)

(21) Appl. No.: 18/736,194

(22) Filed: Jun. 6, 2024

Related U.S. Application Data
(63) Continuation-in-part of application No. 18/090,771, filed on Dec. 29, 2022, now Pat. No. 12,067,027.

(51) Int. Cl. H04L 43/06; H04L 43/04; H04L 67/02

(52) U.S. Cl. CPC H04L 43/06; H04L 43/04; H04L 67/02

(57) ABSTRACT

In one general aspect, the method may include providing a user interface on a web server for users to upload audit criteria, where audit criteria further may include a mode of collection to by utilized by a collector module. Said method may also include installing a plurality of agents for automated data collection, where the agents are software modules controlled by an LLM network module. Said method may furthermore include receiving audit criteria from users in predefined template documents into the LLM network module. Said method may in addition include processing the audit criteria by the LLM network module and triggering automatic data collection by a collector to create collected data.

### CROSS-REFERENCE TO RELATED APPLICATION

This application is a continuation-in-part of commonly assigned and co-pending patent application Ser. No. 18/090,771, filed Dec. 29, 2022, the disclosure of which is hereby incorporated by reference in its entirety.

### BACKGROUND

Network Audits play an important role in managing network infrastructure to ensure secure, efficient and reliable network operations. Network audits are used to make sure the network infrastructure is compliant with expected behavior and free from security vulnerabilities. They also help with asset management in terms of both software, hardware and future capacity planning based on the usage.

Conventionally, network audits are performed manually on an as needed basis. The audit criteria vary based on the type of the organization, for example a security team could be interested in vulnerability patches and configuration related to security breaches, whereas a network architecture team will be interested in the config compliance for different layers of the network. The report generation based on user personas requires manual effort to customize the data collected and presented in a specific format.

Even with the existence of automated tools to collect the data, it requires considerable manual effort to process, normalize and present audit reports customized for various user requests. These traditional methods, often manual and time-consuming, pose risks of errors and inefficiencies.

### SUMMARY

The present disclosure provides systems and methods of utilizing customized templates and data collection processes to perform AI-assisted network audits. The disclosed systems increase efficiency and compliance in audit processes in network management by providing methods for automating data extraction and report generation. According to an embodiment, an LLM-based process and architecture herein described as a Network Copilot or a LLM network module is utilized to verify accuracy and efficiency in audit report creation and to adapt to evolving audit requirements, significantly enhancing compliance management practices.

In one general aspect, the method may include providing a user interface on a web server for users to upload audit criteria, where audit criteria further may include a mode of collection to by utilized by a collector module. Said method may also include installing a plurality of agents for automated data collection, where the agents are software modules controlled by an LLM network module. Said method may furthermore include receiving audit criteria from users in predefined template documents into the LLM network module. Said method may in addition include processing the audit criteria by the LLM network module and triggering automatic data collection by a collector to create collected data. Said method may moreover include correlating the collected data via a correlate module to create correlated data. Said method may also include normalizing, via a normalizer module, the correlated data across a plurality of vendors to create normalized data. Said method may furthermore include generating a unified audit report document file based on the normalized data. Other embodiments of this aspect include corresponding computer systems, apparatus, and computer programs recorded on one or more computer storage devices, each configured to perform the actions of the methods.

### BRIEF DESCRIPTION OF THE DRAWINGS

FIG. 1 illustrates a network environment of a network state data processing platform according to an embodiment of the present disclosure.

FIG. 2 is an implementation of a process architecture according to an embodiment of the present disclosure.

FIG. 3A is a flowchart of a process of creating a generative AI framework on network state telemetry. FIG. 3B is a flow chart that is a continuation of FIG. 3A and schematically illustrates a method of creating a data lake according to an example of the present disclosure.

FIG. 4 is a network architecture according to an embodiment of the present disclosure.

FIG. 5 is a process according to an embodiment of the present disclosure.

### DETAILED DESCRIPTION

The present disclosure presents a novel system and method for automating the generation of compliance audit reports for networks in various deployments including data center, telco and edge. By leveraging a Large Language Model (LLM) based Network Copilot, the system simplifies the audit process for network administrators and operators.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

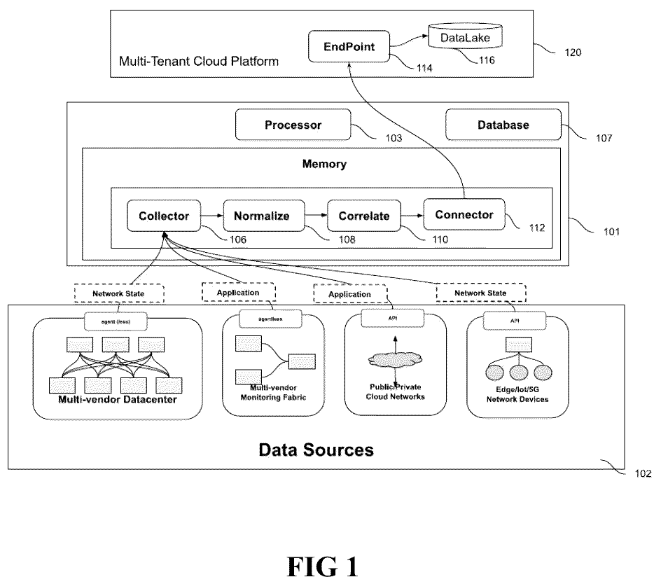

FIG. 1 is a block diagram that schematically illustrates a computing system 101, in accordance with an embodiment of the present invention. System 101 may comprise, for example, a data center, a high-performance system, or a similar computing system. According to an embodiment, system 101 further comprises a processor 103, memory 105, and a database 107, wherein the system may communicate with one or more data sources 102 via a collector module 106. The system 101 may also be configured to communicate with external devices, such as user devices, to receive input and provide output.

The data sources 102 may include all industries where network infrastructure exists. Data sources 102 can be, for example, Enterprise data centers, cloud networks, both public and private, network devices for IoTs and edge 5G networks or cellular networks, or any other networks which connect compute/storage devices.

It can be appreciated that according to this exemplary system, a data lake can exist in a multitude of locations if it has the required underline infrastructure available. Locations can include on-premises data centers, cloud agnostic data infrastructure, and public cloud specific infrastructure. The amount of data in these data centers also may vary depending on customer use cases, for example NetOps use cases, data analytics use cases or security use cases.

System 101 may further comprise a number of functional modules (including the collector, normalizer, and connector modules) that are connected in a seamless and efficient process, thus allowing for efficient and accurate transformation of the input data. At this stage the data collected from collector module 106 varies in syntax, type and value ranges because of the various hardware and software specifications across the various data sources.

According to an embodiment, collector module 106 is configured to collect all the data from data sources 102. According to further embodiment, data sources 102 further comprises proposed agents and vendor agents. According to a further embodiment, data is collected by the collector module 106 by using a push notification from the agents rather than a pull, thus reducing the complexity of the collector design. Data sources can include organic agents to extract network state including platform, control plane and data plane. Data sources can also be agentless, which will use the existing network infrastructure components like SYSLOG, SNMP for network state and sFlow, netflow, metadata extraction using control plane rules. Data sources can also be connected to APIs and use vendor provided APIs provided by the network infrastructure.

Normalizer module 108 is configured to normalize the data collected by the collector module 106 across data sources 102. a unified insight or unified state of the multivendor environment. Once the data has been processed by normalizer module 108, it is fed into correlate module 110 which critically implements noise reduction and transforms the normalized data into a targeted optimized data that is ready for exporting to the cloud data lake.

According to a further embodiment, correlate module 110 correlates the time-series data points across the various sub-systems and creates a single stream of data. Examples of sub-systems that may be used by the system include, but are not limited to, syslog, APIs, traffic, failures, application data generated by the system or its users, and user data provided by individuals interacting with the system. There are various use cases for single stream of data created by correlate module 110, including network utilization monitoring, anomaly detection, and failure analysis. It can be appreciated that system is designed to be flexible and adaptable, allowing it to be applied to a wide range of applications and industries. Once correlate module 110 has created the single stream of data it is ready to be sent to connector module 112 and eventually exported.

Connector module 112 is responsible for the export of the data prepared by correlate module 110 from the on-site IT infrastructure datacenter to the Multi-Tenant Cloud Platform 120 by creating a data cloud connector. It can be appreciated that connector module 112 supports connecting to various cloud endpoints which are cloud agnostic and also transports the data over a secured and persistent channel. According to an embodiment, connector module 112 also serializes the data into a compressed format for better performance.

According to an embodiment, Endpoint 114 can be a managed cloud service which will receive the data cloud connector from connector module 112. According to a further example, Endpoint 114 utilizes auto-scaling properties to support scalable and distributed environments. Endpoint 114 also de-serializes the data received and pushes the multi-vendor data to the database hosted in the cloud infrastructure.

According to an embodiment, DataLake 116 is a cloud agnostic database which maintains the time-series data received from the on-site IT infrastructure, maintains raw and tabularized data. In a further example, the raw data format can be used by Artificial Intelligence and machine learning applications for various use cases relating to alerting, prediction, forecasting and deriving automatic troubleshooting. The tabularized data is consumed by observability applications for creating various dashboards for trend analysis and reporting.

The present disclosure further implements a network management system and architecture, referred to as Network Copilot, designed to streamline network operations and enhance performance analysis.

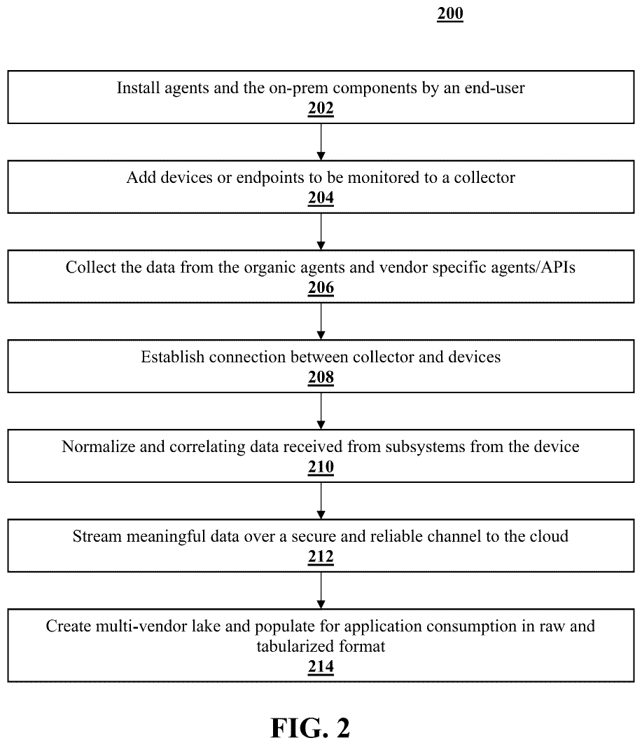

FIG. 2 is a flowchart of an exemplary process 200. In some implementations, one or more process blocks of FIG. 2 may be performed by a device.

As shown in FIG. 2, process 200 may include installing agents and the on-site IT infrastructure components by an end-user (block 202). As also shown in FIG. 2, process 200 may include adding devices or endpoints to be monitored to a collector module (block 204). As further shown in FIG. 2, process 200 may include collecting the data from the organic agents and vendor specific agents/APIs (block 206). As also shown in FIG. 2, process 200 may include establishing connection between the collector module and devices (block 208). As further shown in FIG. 2, process 200 may include normalizing and correlating data received from subsystems from the device (block 210). As also shown in FIG. 2, process 200 may include streaming meaningful data over a secure and reliable channel to the cloud (block 212). For example, the process may stream meaningful data over a secure and reliable channel to the cloud, as described above. As further shown in FIG. 2, process 200 may include creating multi-vendor lake and populate for application consumption in raw and tabularized format (block 214).

Although FIG. 2 shows example blocks of process 200, in some implementations, process 200 may include additional blocks, fewer blocks, different blocks, or differently arranged blocks than those depicted in FIG. 2. Additionally, or alternatively, two or more of the blocks of process 200 may be performed in parallel.

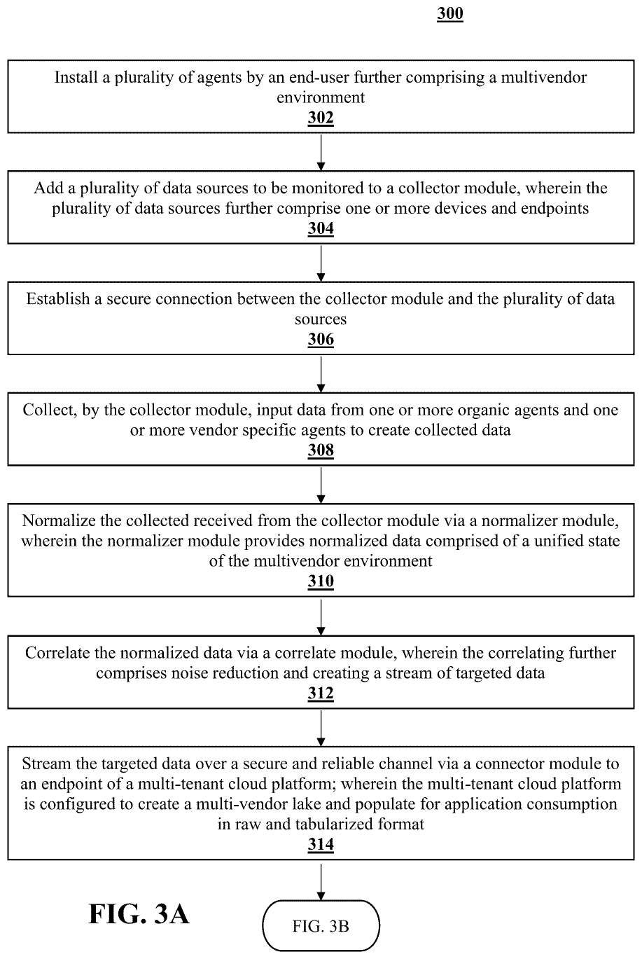

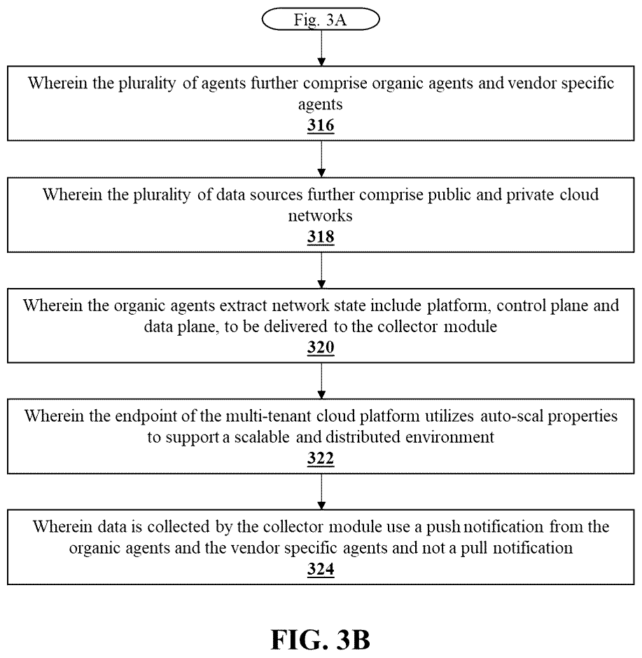

FIG. 3A is a flow chart of a more detailed process 300, according to an example of the present disclosure. FIG. 3B is a flow chart that is a continuation of FIG. 3A and schematically illustrates a method of creating a data lake according to an example of the present disclosure. According to an example, one or more process blocks of FIG. 3A and FIG. 3B may be performed by device.

As shown in FIG. 3A, process 300 may include installing a plurality of agents by an end-user may include a multivendor environment (block 302). As in addition shown in FIG. 3A, process 300 may include adding a plurality of data sources to be monitored to a collector module, where the plurality of data sources further may include one or more devices and endpoints (block 304). As also shown in FIG. 3A, process 300 may include establishing a secure connection between the collector module and the plurality of data sources (block 306). As further shown in FIG. 3A, process 300 may include collecting, by the collector module, input data from one or more organic agents and one or more vendor specific agents to create collected data (block 308). As in addition shown in FIG. 3A, process 300 may include normalizing the collected received from the collector module via a normalizer module, where the normalizer module provides normalized data may include of a unified state of the multivendor environment (block 310). As also shown in FIG. 3A, process 300 may include correlating the normalized data via a correlate module, where the correlating further may include noise reduction and creating a stream of targeted data (block 312). As further shown in FIG. 3A, process 300 may include streaming the targeted data over a secure and reliable channel via a connector module to an endpoint of a multi-tenant cloud platform; where the multi-tenant cloud platform is configured to create a multi-vendor lake and populate for application consumption in raw and tabularized format (block 314). For example, the process may stream the targeted data over a secure and reliable channel via a connector module to an endpoint of a multi-tenant cloud platform; where the multi-tenant cloud platform is configured to create a multi-vendor lake and populate for application consumption in raw and tabularized format, as described above. As further shown in FIG. 3B, process 300 may include the plurality of agents further comprising organic agents and vendor specific agents (block 316). As further shown in FIG. 3B, process 300 may include the plurality of data sources further comprising public and private cloud networks (block 318). As further shown in FIG. 3B, process 300 may include the organic agents extracting network state including platform, control plane, and data plane to be delivered to the collector module (block 320). As further shown in FIG. 3B, process 300 may include the endpoint of the multi-tenant cloud platform utilizing auto-scale properties to support a scalable and distributed environment (block 322). As further shown in FIG. 3B, process 300 may include data collected by the collector module using a push notification from the organic agents and the vendor specific agents and not a pull notification (block 324).

Process 300 may include additional implementations, such as any single implementation or any combination of implementations described below and/or in connection with one or more other processes described elsewhere herein. In a first implementation, the plurality of agents further may include organic agents and vendor specific agents.

In a second implementation, alone or in combination with the first implementation, the plurality of data sources further may include public and private cloud networks.

In a third implementation, alone or in combination with the first and second implementation, the organic agents extract network state including platform, control plane and data plane, to be delivered to the collector module.

In a fourth implementation, alone or in combination with one or more of the first through third implementations, the endpoint of the multi-tenant cloud platform utilizes auto-scaling properties to support a scalable and distributed environment.

In a fifth implementation, alone or in combination with one or more of the first through fourth implementations, data is collected by the collector module using a push notification from the organic agents and the vendor specific agents and not a pull notification.

The system may utilize a vendor-agnostic data mobility platform (ONES) for seamless data ingestion and normalization, ensuring compatibility across diverse network architectures. By utilizing interfaces including SNMP, streaming, and sFlow protocols, the system enables NOS-agnostic data collection, providing comprehensive insights into network inventory, health, utilization, and application layer (L4-L7) behavior.

The system may employ a foundation model (7B) trained and fine-tuned to accommodate various network environments, enhancing its analytical capabilities. Additionally, the system can integrate a Retrieval-Augmented Generation (RAG) embedding model for nuanced data representation and analysis, according to an embodiment of the present disclosure.

The system features a simplified Prompt-based User Interface (UI) for intuitive interaction and supports the saving and exporting of customer-driven questions for iterative training and refinement, as described. Furthermore, the system facilitates the importation of customer-defined business expectations. It can be appreciated that such an approach offers flexibility and scalability in network management.

According to an embodiment, the system comprises a distributed hardware architecture designed to handle the complexities of modern network environments. According to an embodiment, the system comprises modular components including web servers, storage units, and networking devices. The web servers host the software components responsible for data ingestion, normalization, analysis, and user interface functionalities.

In addition to the web servers, the system incorporates specialized networking devices for data collection and transmission. These devices support interfaces such as SNMP, streaming, and sFlow, enabling seamless integration with diverse network infrastructures. Moreover, the system employs storage units, such as solid-state drives (SSDs) or network-attached storage (NAS), to store and retrieve network data for analysis and archival purposes.

According to an embodiment, the system implements cloud infrastructure for scalable deployment and resource management. Cloud-based components provide additional computational power and storage capacity as needed, ensuring optimal performance and scalability in dynamic network environments. The distributed hardware architecture of the system ensures resilience, scalability, and high availability, making it suitable for deployment in enterprise-level networks with stringent performance requirements.

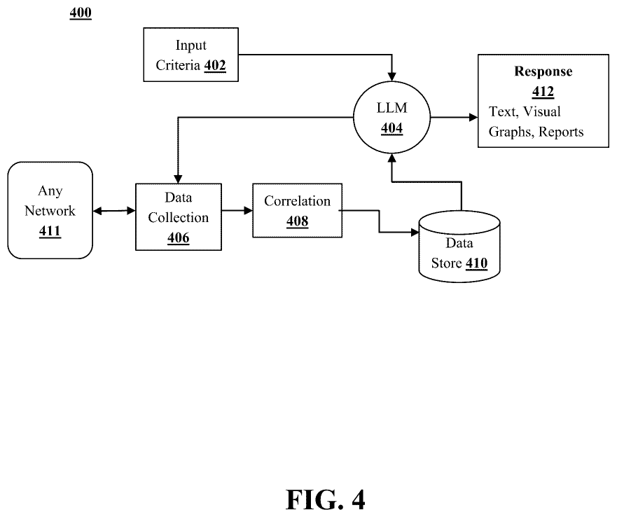

FIG. 4 discloses a system architecture and method according to an embodiment of the present disclosure. The method allows network users to dynamically provide the audit criteria 402 in predefined templates (for example as Excel sheets, word documents with predefined formats) via an Input Module. The criteria can also specify the type of metrics, mode of collection, mandatory requirements etc. The system provides an interface for users to upload audit criteria. The backend, powered by the architecture described herein, processes these inputs and triggers the automated data collection.

According to an embodiment the Input Module serves as the primary interface for user interaction. It features an interface where the predefined templates are submitted. This module can be equipped with a Validation Layer, ensuring that all inputs adhere to predefined formats and criteria for further processing. The hardware components for this module might include high-performance servers to manage multiple simultaneous user requests and data validation processes.

The system provides sub-agents for automated data collection which can utilize the mode of collection mechanism specified in the input criteria. The data collection sub-agents can also be integrated with the existing automated tools if necessary. According to an embodiment, the sub-agents are controlled by the LLM powered Network Copilot 404, which functions as a processing Core of the architecture that is configured to process the core computational tasks. This may include a Query Processor that parses and interprets user input to determine the required processing. A Data Fetching Module may integrate with necessary data from integrated databases or external sources. Additionally, a Data Processing Unit, potentially utilizing GPUs for intensive data computation, can perform the analysis and manipulation of fetched data according to the user's request.

According to an embodiment, a data collection service 406 receives data from Network Copilot 404 and feeds it to correlation module 408 which is responsible for correlating the data collected and potentially normalizing across various vendors to generate a unified audit report in various formats (PDFs, Word formats, graphs etc) and saving it to data store 410, which may include one or more data storage systems.

Network Copilot 404 then uses this extracted information to service the various audit report requests from the end user and deliver a request response 412.

The audit reports can be regenerated using last collected information or can be triggered on an on-demand basis. The system offers extended capabilities for incremental updates to the audit report, accommodating changes in audit criteria.

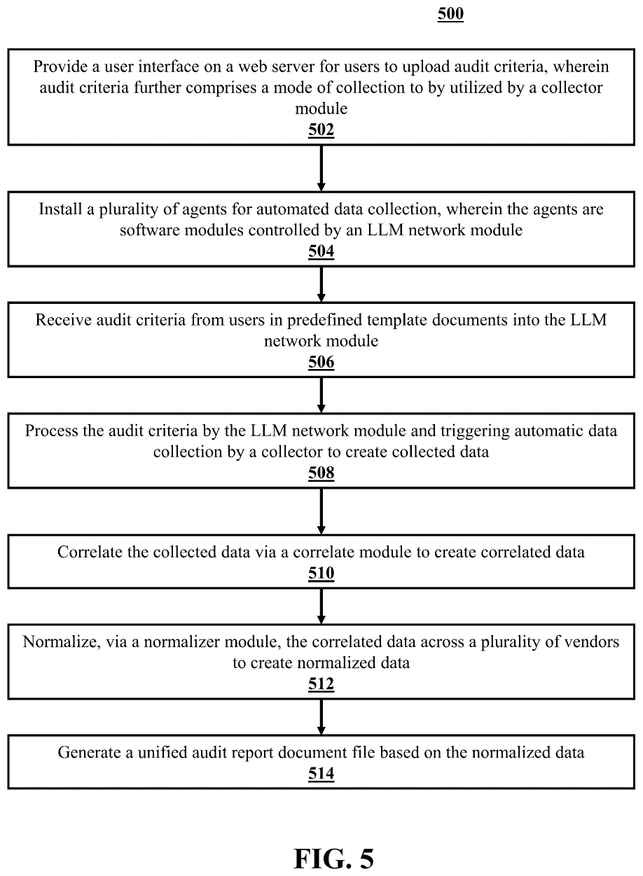

FIG. 5 is a flowchart of an example process 500 which describes the functions of a method of AI-assisted network audits in more detail. That is, one or more process blocks of FIG. 5 may be performed by a system architecture incorporating an LLM.

As shown in FIG. 5, process 500 may include providing a user interface on a web server for users to upload audit criteria, where audit criteria further may include a mode of collection to by utilized by a collector module (block 502). For example, collecting network performance data to detect failures may include providing a user interface on a web server for users to upload audit criteria. These criteria further specify the mode of collection to be utilized by a collector module, such as active monitoring (sending test traffic), passive monitoring (collecting data from existing traffic), or event-driven monitoring (triggering data collection based on specific network events). The collector module gathers the data accordingly, which is then processed and analyzed to identify anomalies or failures using statistical analysis, pattern recognition, and machine learning techniques. The results are intended to be presented in a user-friendly report, highlighting detected failures, and generating alerts for critical issues. Users can provide feedback to adjust the audit criteria and collection modes, enhancing the system's effectiveness in future data collection and analysis. As also shown in FIG. 5, process 500 may include installing a plurality of agents for automated data collection, where the agents are software modules controlled by an LLM network module (block 504). These agents are deployed across various nodes in the network to continuously monitor and collect performance data. The LLM network module coordinates the agents, ensuring they operate efficiently and in unison. The collected data is then aggregated and analyzed by the LLM network module, which uses advanced algorithms and machine learning techniques to detect anomalies and potential failures. This system allows for real-time monitoring and rapid identification of issues, enhancing the overall reliability and performance of the network. As further shown in FIG. 5, process 500 may include receiving audit criteria from users in predefined template documents into the LLM network module (block 506). As also shown in FIG. 5, process 500 may include processing the audit criteria by the LLM network module and triggering automatic data collection by a collector to create collected data (block 508). For example, a collector software module may process the audit criteria trigger automatic data collection to create collected data, as described above. According to an embodiment, the correlate module takes raw performance data from various sources and aligns it based on time stamps, events, and network conditions to identify patterns and relationships. By correlating this data, the module can provide a more comprehensive view of network performance, revealing insights that may not be apparent from isolated data points. As also shown in FIG. 5, process 500 may include normalizing, via a normalizer module, the correlated data across a plurality of vendors to create normalized data (block 512). As further shown in FIG. 5, process 500 may include generating a unified audit report document file based on the normalized data (block 514), which may then be served on the user by the LLM network copilot.

Process 500 may include additional implementations, such as any single implementation or any combination of implementations described below and/or in connection with one or more other processes described elsewhere herein. In a first implementation, the predefined template may include documents with predefined formats.

In a second implementation, alone or in combination with the first implementation, the audit criteria can also specify a variable of metrics and mode of collection.

In a third implementation, alone or in combination with the first and second implementation, the audit reports are regenerated using last collected information.

In a fourth implementation, alone or in combination with one or more of the first through third implementations, the method provides incremental updates to the audit reports including changes in audit criteria.

In a fifth implementation, alone or in combination with one or more of the first through fourth implementations, the audit reports are regenerated on an on-demand basis.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

What has been described and illustrated herein is an example along with some of its variations. The terms, descriptions and figures used herein are set forth by way of illustration only and are not meant as limitations. Many variations are possible within the spirit and scope of the subject matter, which is intended to be defined by the following claims--and their equivalents—in which all terms are meant in their broadest reasonable sense unless otherwise indicated.

What is claimed is:

1. A method, comprising:
providing a user interface on a web server for users to upload audit criteria, wherein audit criteria further comprises a mode of collection to by utilized by a collector module;
installing a plurality of agents for automated data collection, wherein the agents are software modules controlled by an LLM network module;
receiving audit criteria from users in predefined template documents into the LLM network module;
processing the audit criteria by the LLM network module and triggering automatic data collection by a collector to create collected data;
correlating the collected data via a correlate module to create correlated data;
normalizing, via a normalizer module, the correlated data across a plurality of vendors to create normalized data;
generating a unified audit report document file based on the normalized data.

2. The method of claim 1, wherein the predefined template further comprises documents with predefined formats.

3. The method of claim 2, wherein the criteria can also specify a variable of metrics and mode of collection.

4. The method of claim 3, wherein the audit reports are regenerated using last collected information.

5. The method of claim 3, wherein the audit reports are regenerated on an on demand basis.

6. The method of claim 4, wherein the method provides incremental updates to the audit reports including changes in audit criteria.

7. A system comprising:
one or more processors configured to:
provide a user interface on a web server for users to upload audit criteria, wherein audit criteria further comprises a mode of collection to by utilized by a collector module;
install a plurality of agents for automated data collection, wherein the agents are software modules controlled by an LLM network module;
receive audit criteria from users in predefined template documents into the LLM network module;
process the audit criteria by the LLM network module and triggering automatic data collection by a collector to create collected data;
correlate the collected data via a correlate module to create correlated data;
normalize, via a normalizer module, the correlated data across a plurality of vendors to create normalized data;
generate a unified audit report document file based on the normalized data.

8. The system of claim 7, wherein the predefined template further comprises documents with predefined formats.

9. The system of claim 8, wherein the criteria can also specify a variable of metrics and mode of collection.

10. The system of claim 9, wherein the audit reports are regenerated using last collected information.

11. The system of claim 10, wherein the system provides incremental updates to the audit report including changes in audit criteria.

12. The system of claim 9, wherein the audit reports are regenerated on an on-demand basis.
